(19) United States
(12) Patent Application Publication
(10) Pub. No.: US 2008/0092369 A1
(43) Pub. Date: Apr. 24, 2008

(54) Combination of two machines for making a cap of containers

(76) Inventor: Chi-Ti Liao, Fongyuan City (TW)

Correspondence Address: LIAO, CHI-TI, P.O. Box 697, Taichung County, Fongyuan City 420, omitted

(21) Appl. No.: 11/524,904

(22) Filed: Sep. 22, 2006

(51) Int. Cl. B23P 19/00; B26D 7/06; B26D 5/08

(52) U.S. Cl. 29/650; 83/401; 83/549

(57) ABSTRACT

A combination of two machines for making a cop of containers includes a forming machine connected with a cutting machine by a transferring disk. The forming machine has a input disk and the cutting machine has a output disk on a side opposite to the transferring disk. The forming machine further has a main shaft on the center of a circular base plate, a ships remover inside the input disk, a revolving annular plate and several cap forming devices revolving around the main shaft which has an upper guide annular groove including a descending section and a lower guide annular groove including a V-shaped quick descending section to receive a plurality of rollers sliding therein. When a cap is entered into the forming machine and finished chips removing and forming process. Then transferred into the cutting machine for making a breading-line herein.

### BACKGROUND OF THE INVENTION

The present invention relates to cap making and more particularly to a combination of two machines for making a cap for containers which includes a cap forming machine and a breaking-line cutting machine to corporately finish a cap for containers.

As we know that a cap for covering the bottle, milk container and etc. is made of plastic material. To open the cap is to twist the cap to remove the cap on a breaking-line. The former cap only has a lashing ring under the breaking-line. When twist the cap, the lashing ring rotates together with the breaking-line that can not remove the cap from the container. Latterly the producers add a plurality of the reinforcement plates spacedly and introrsely disposed on the top of the lashing ring and then are pressed downward so when the cap covers the opening of the container, those reinforcement plates are positioned between the opening of the container and the lashing ring so as to provide adequate friction force to limit the lashing ring to rotate together with breaking-line such that the cap is easily to remove from the opening on the breaking line.

FIG. 1 shows a half-finished cap 1 which has a serrated periphery 5 on the top of a bottom, a lashing ring 3 on the top of the serrated periphery 5 and a plurality of reinforcement plates 4 spacedly an introrsely disposed on the top of the lashing ring 3. FIG. 2 is a finished cap 1′ on which the reinforcement plates 4 are bent down still leaving a tilting angle with the lashing ring 3 therebetween and a breaking line is cut between the lashing ring 3 and the serrated periphery 5. When the finished cap 1′ covers the container the reinforcement plates 4 are engage with lashing ring 3 and the opening of the container therebetween so as to provide adequate friction force to prevent the lashing ring to be rotated with serrated periphery that the cap 1′ is easily removed.

The reinforcement plates 4 have to be made accurately and spacedly. If there is any defect on it, the cap becomes to cast away. Further, during the injection of the cap 1, a residue must remain on of the bottom. The residue is a tip that has to be removed. However, there is no bending, forming and cutting integrate operations in a machine. If each step by different machine, it should be a hardship for the producer.

Nowadays a forming machine in the market is mainly bending down the reinforcement plates 4 and includes two actions of pressing down and removing the caps to the output disk. Because this machine is not accurate that usually causes the cap 1 fed in unbalanced and/or bent not smoothly so as the reinforcement plates 4 are biased and creasy.

### SUMMARY OF THE PRESENT INVENTION

The present invention has a main object to provide a combination of two machines for making a cap of containers which includes a forming machine and a breaking-line cutting machine connected by a transferring disk. The forming machine is functioned to remove the residues on the cap and stroking the reinforcement plates 4 to be bent down. Then transfers the cap into the breaking-line cutting machine which cuts swiftly the breaking-line to finish a perfect cap 1′ before it is collected through a output disk.

Another object of the present invention is to provide a combination of two machines for making a cap of containers in which the forming machine is previously balancing the cap then strokes the reinforcement plates 4 which are perfectly bent down in the cap without defect.

Accordingly, the combination of two machines for making a cap of containers of the present invention comprises a forming machine combined with cutting machine each of which has a circular base connected through a transferring dish therebetween.

The forming machine has a main shaft having an upper annular guide groove and a lower annular guide groove to facilitate a plurality of rollers rotatably siding therein.

A revolving annular plate around the bottom of the main shaft having a plurality of outer concaves and a plurality of inner concaves, wherein the outer concaves are capable of hooking the caps.

An input disk, a transferring desk and a output disk sequentially positioned at the opposite side of the circulate bases wherein the input disk is function to receive the half-finished cap 1 into the forming machine for removing the residues and for the bending the reinforcement plates 4. The transferring disk is functioned to transfer the formed caps into the cutting machine for cutting the breaking-line in the cap and output disk is to transfer the finished caps 1′ to a collection member. So that an integrated operation is therefore achieved. The present invention will become more fully understood by reference to the following detailed description thereof when read in conjunction with the attached drawings.

### BRIEF DESCRIPTION OF THE DRAWINGS

FIG. 1 shows a half-finished cap 1,

FIG. 2 shows a finished cap 1′,

FIG. 3 shows a combination of two machines,

FIG. 4 is a perspective view showing a part of the forming machine,

FIG. 5 shows a cutting device inside the input disk,

FIG. 6 shows a top portion on the top of the cutting machine,

FIG. 7 shows that the cutting device is cutting a residue on the half-finished cap 1,

FIG. 8 shows a pressing member being stroking a half-finished cap 1,

FIG. 9 shows a stopping rod stopping the cap before stroking to bend down the reinforcement plates,

FIG. 10 shows a half-finished cap 1 is under the pressing member,

FIG. 11 shows a that the reinforcement plates 4 of the cap 1 is about to bend down by the stroking of the pressing member,

FIG. 12 shows a that the reinforcement plates 4 of the cap 1 is already bent down by the pressing member,

FIG. 13 shows the pressing member retreating upward,

FIG. 14 shows the stopping rod is moved upward from the cap 1, and

FIG. 15 shows an alternate embodiment of the cutting device.

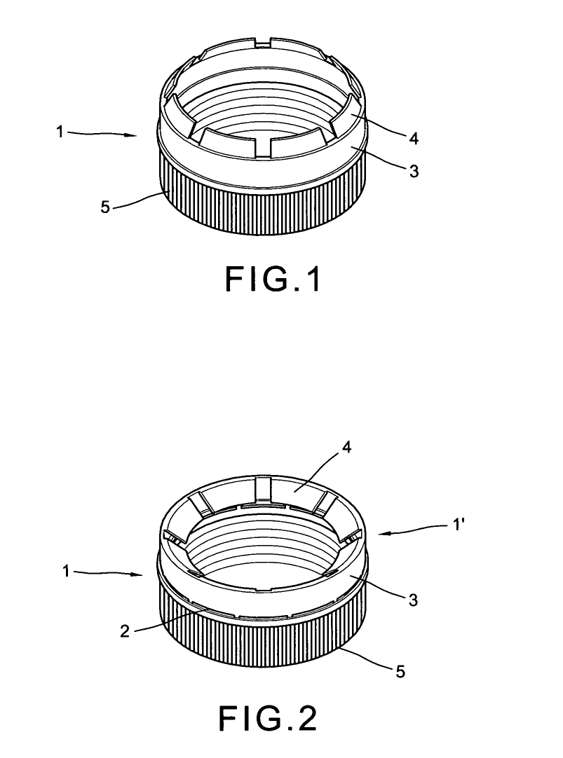

### DETAILED DESCRIPTION OF THE PREFERRED EMBODIMENT

With reference to the drawing and initialed from FIGS. 2, 3 and 4, the combination of two machine for making a cap of containers of the present invention comprises a forming machine 100 connected with a cutting machine 200 by a transferring disk 16. The forming machine is functioned to receive the half-finished caps 1 and transferring the formed cap 2 to the cutting machine for making breaking-line on the cap 1′. The cutting machine 200 is already filed in a U.S. Pending application with a Ser. No. 11/258,102, so here needs not redundant description.

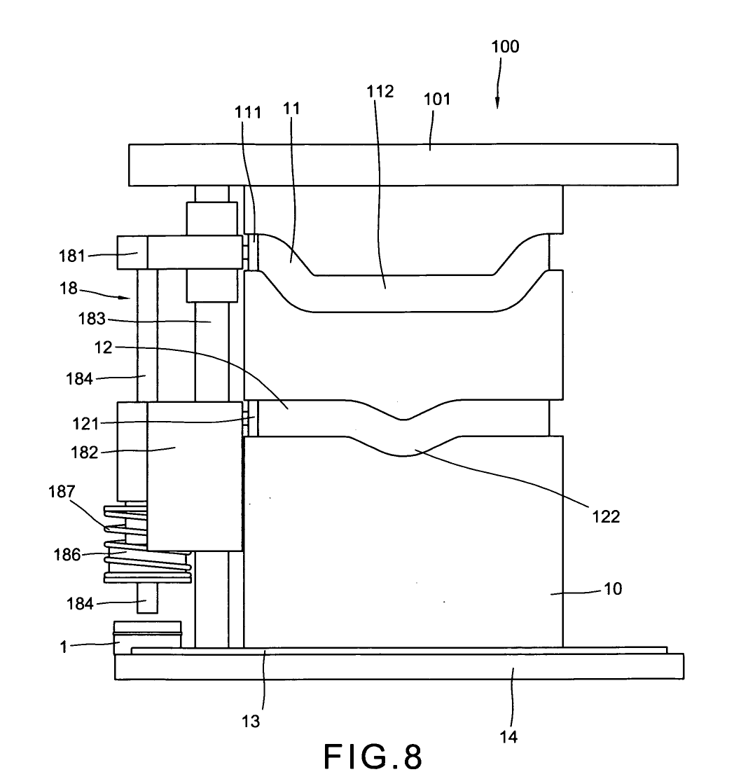

The forming machine 100 has a main shaft 10 suspended by a V-shaped supporter 101 at center in the outer periphery thereof is an upper annular guide groove 11 and a lower annular guide groove 12. The upper annular groove 11 included a descending section 112 of long range of travel. The other portion is of horizontal. Whereas the lower annular groove includes a V-shaped quick descending section 122 of short range of travel. Both of the annular grooves 112 and 122 are provided to receive a plurality of rollers 111 and 121 to rotatably slide therein (as show in FIG. 8). The cutting machine 200 has also suspended from a V-shaped supporter 201 and each of the V-shaped supporters 101 and 201 are supported by a pair of columns and the bottom of the main shaft 10 is integrated with a circular base plate 14.

A revolving angler plate 13 on the top of the base plate 14 and revolved around the main shaft 10 is combined by a plurality of templates and has a plurality of outer concaves 131 for hooking the half-finished caps 1 and a plurality of inner concaves 132. The base plate 14 further has an arcuate wall 141 on an outer periphery and extends from the input disk 15 to the transferring disk 16 and forms a passageway with the rotating ring 13 therebetween for facilitating the half-finished caps 1 to safely go from the input disk 15 to the transferring disk 16. The cutting machine further has an output disk 21 on the opposite side of the transferring disk 16.

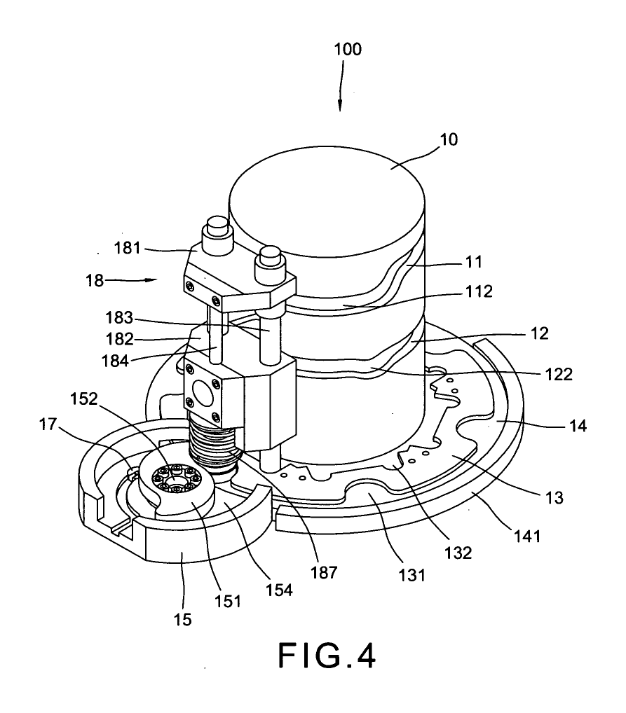

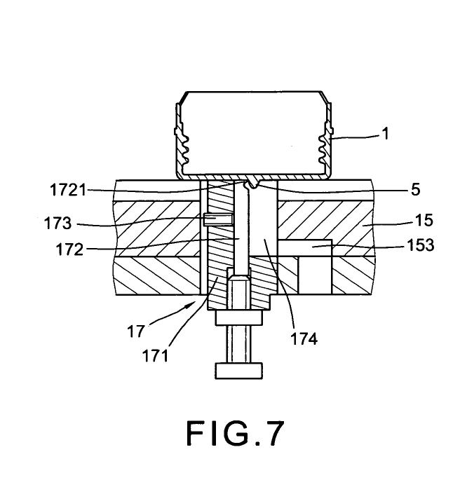

Both the disks 15, 16 and 21 has an inlet, an outlet and a double headed pusher 151, 161 and 211 rotatably pivoted to an axis 152,162 and 212 at center the of the disks 15, 16 and 21 with a bearing engaged therebetween. The double headed pushers 151, 161 and 211 each has a pair of inverse curves on opposite side and rotated clockwise to push in and out of the caps through the inlet and the outlet. Wherein the input disk further has a chips remover 17 inside a bottom and composed of a tube 171, a cutter 172 with a blade 1721 at upper end and an adjustable elastic stopper 175. The cutter is a cylinder with the blade 1721 embedded in a bottom of the desk 15 and the cutter 172 is hiding in a chips collection hole 174 of the tube 171 which further has a screw hole for engaging a threaded shank 173 to stop against the cutter 172 and to adjust the cutter to move up and downward. The input disk 15 has a cover 154 beneath the double headed pusher 151 for facilitate an elastic stopping member 175 of the cutter 172 to position on the top of the tube 171. The elastic stopping member 175 has a tubular cover 1751 inside which is a press plate 1752, an elastic plate 1754 biased by a spring 1753 and a nut 1755. The nut 1755 presses the press plate 1752 moving downward to force the spring 1753 and the elastic plate 1754 to jump up and downward to facilitate the half finished caps 1 passing through. Each of the caps 1 will be pressed by the elastic plate a little while to facilitate the blade 1721 of the cutter 172 to remove away the chips on the caps 1 (as shown in FIGS. 4, 5, 6 and 7).

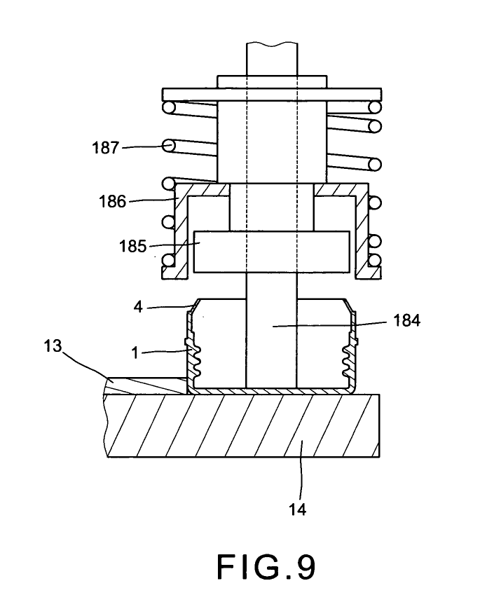

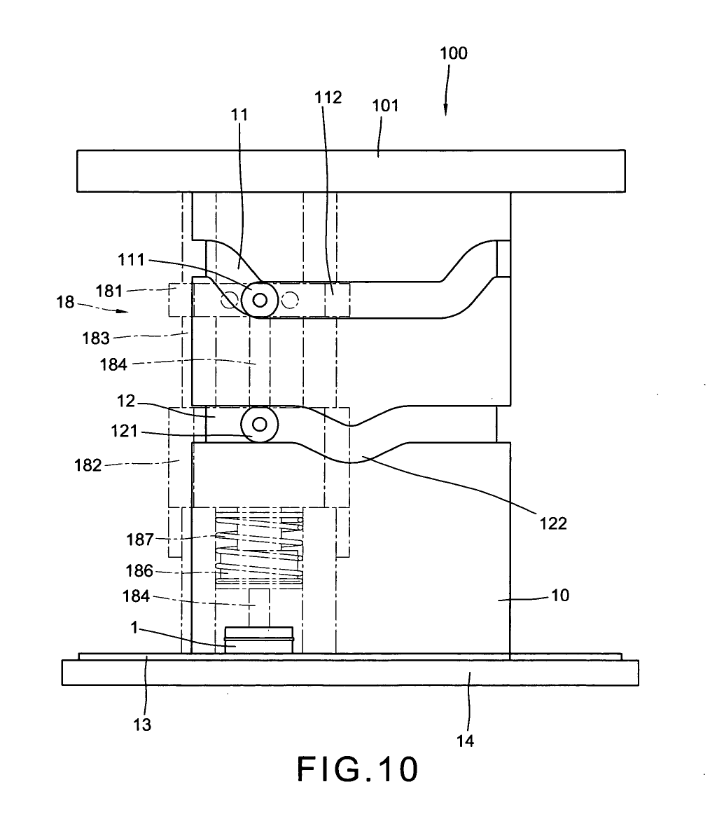

Referring FIGS. 4, 8, 9 and 10, there is several cap forming device 18 positioned inside the circular base plate 14 and spacedly revolved around the main shaft 10. The devices 18 each has an upper pressing plate 181 and a lower pressing plate 182. The upper pressing plates 181 each has a roller (bearing) 111 on the back rotatably sliding in the upper guide groove 11, whereas the lower pressing plate 182 has also a roller (bearing) 121 on the back to rotatably slide in the lower guide groove 12. A pair of axial rods 183 spacedly and slidably penetrate through the rear side of the upper and lower pressing plates 181 and 182 and eventually positioned at a pair of the inner concaves 132 of the revolving annular plate 13 so that the cap forming device are revolving around the main shaft 10 by the revolving annular plate 13. A pressing axis 184 fixedly secures to a front under side of the upper pressing plate 181 and slidably passes through the lower pressing plate 182 so that the pressing axis 184 can move linking-up with the upper pressing plate 181. The axis 184 slidably links up a pressing block 185 and a U-shaped cover 186 at lower end. The U-shaped cover 186 covers the pressing block 185 and is biased on the top by a spring 187 which enable the U-shaped cover 186 to conduct vertical movement and a small gap defined between the pressing block 185 and the U-shaped cover 186.

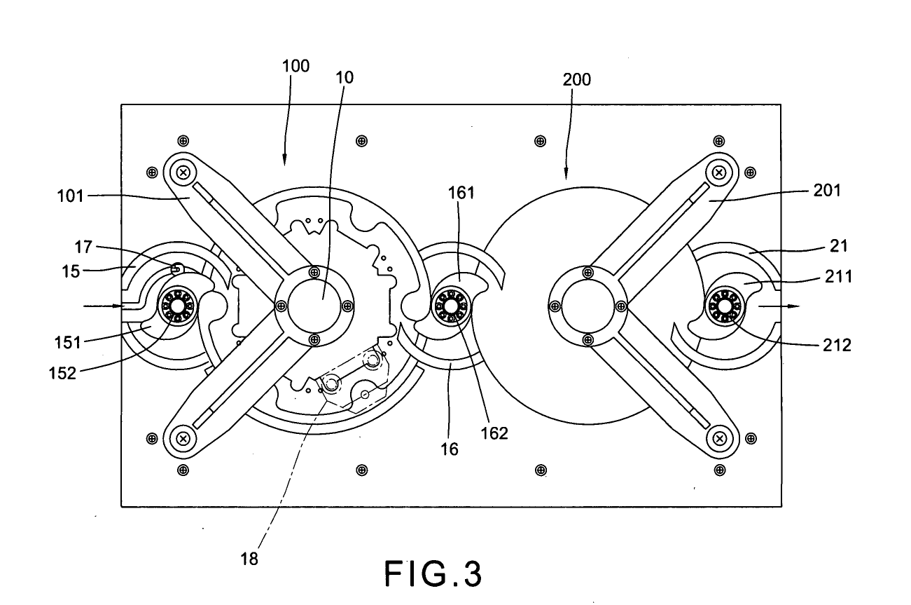

A base box positions under the forming machine 100 and the cutting machine 200 and a motor (not shown) inside box and under the forming machine 100 and actuate the two machine 100 and 200 to operate together by the chains (not shown). The machines 100 and 200 each has a transparent protection cover 102 (as shown in FIG. 3). Each of the covers 102 has several transparent doors and each of the doors has a micro-switch. When the door is open, the switch is functioned to shut the machines 100 and 200 temporarily to avoid the danger.

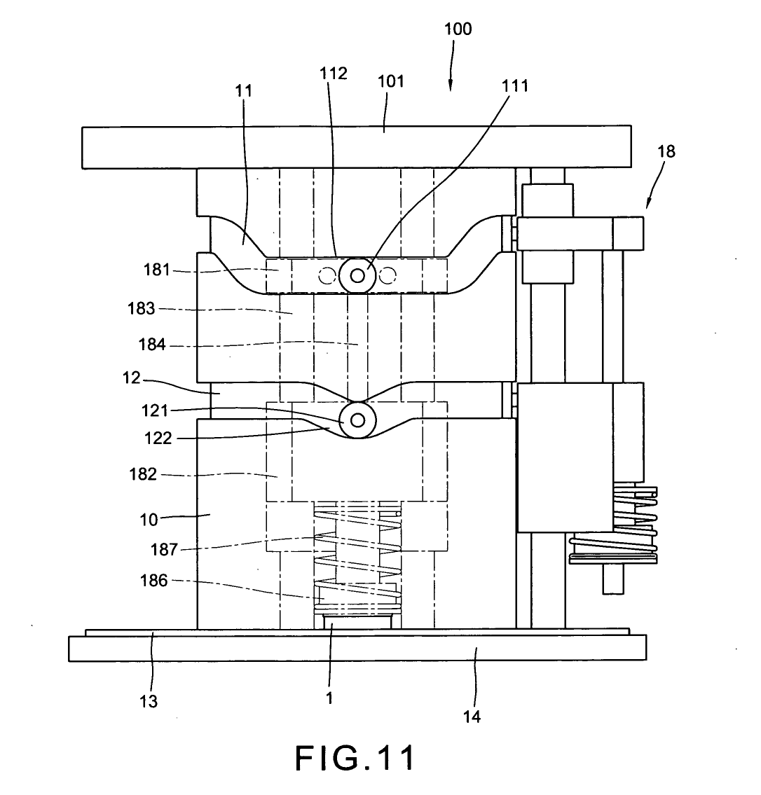

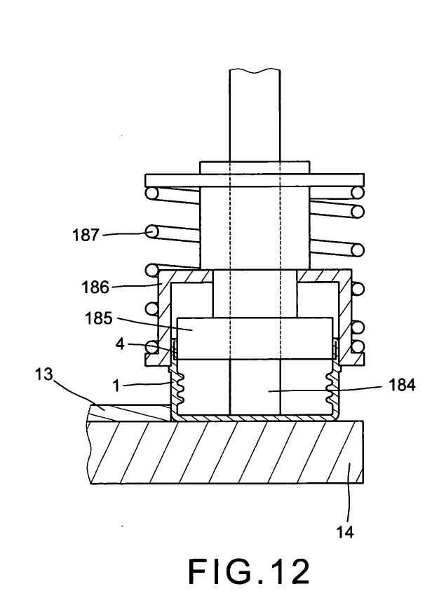

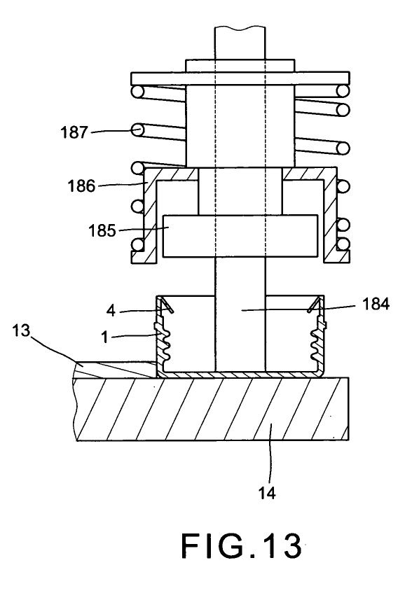

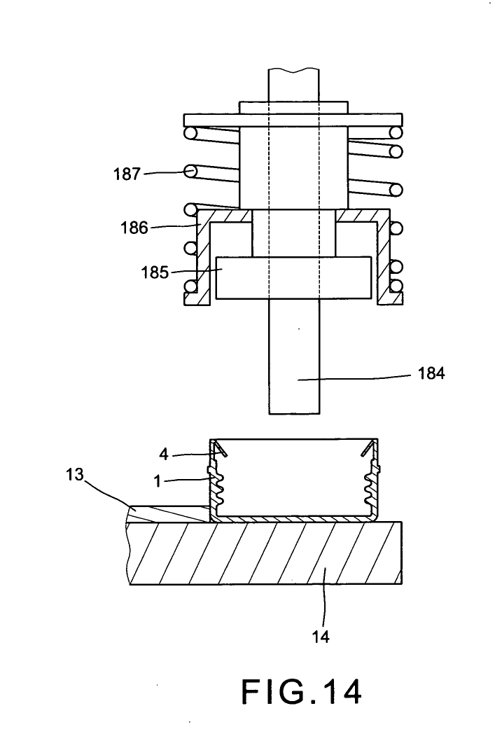

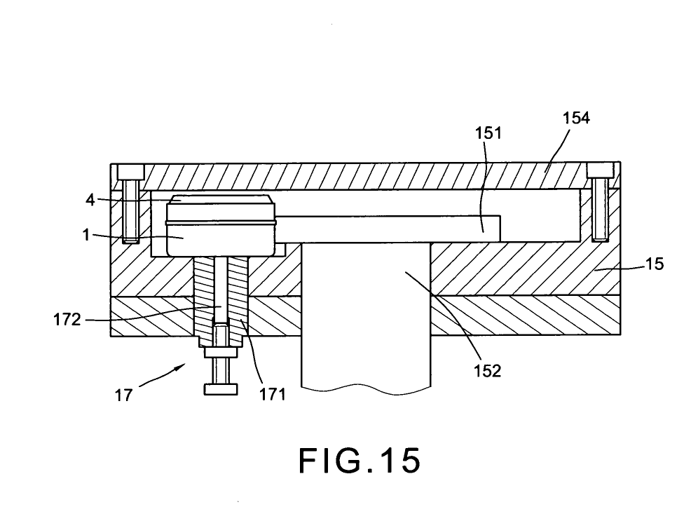

Referring to FIGS. 4, 6 and 7, based on the aforediscussed structure, in operation, a conveyor (not shown) feeds the caps 1 into the input disk through the inlet. The double head pusher 151 pushes the cap 1 one by one about 90° relative to inlet, while the elastic plate 1754 of the stopping member presses downwind to temporarily hold the cap 1 waiting for the cutter 172 of the chips remover 17 to cut the chips away and the chips then drops into the chips collection hole 174 and the absorbing hole 153 of the input disk 15. Then use a hose of a vacuum cleaner (not shown) to suck the chips away from the chips collection hole 174 and the absorbing hole 153 in order avoid the chips to blocked these holes 174 and 153. The chips removed cap is continuously moved by the double headed pusher 151 for about 180° where the out concave 131 of the revolving annular plate 13 enables to accept cap 1 and brings the cap 1 to move forward along the inner side of the arcuate wall 141. This time, the pressing axis 184 is moving down by the downward movement of the upper pressing plate 181 and stops the against the center of the cap 1 to keep the cap 1 to be stable (accurate position without aslant). Immediately, the pressing block begins to press the reinforcement plates 4 and bends the reinforcement plates 4 downward. After the forming process, the cap 1 is released by the pressing axis 184 and moved to the inlet of the transferring disk 16 in which the double headed pusher 161 pushes the cap 1 about 180° to the outlet and simultaneously interred into the cutting machine for making the breaking-line thereon and after the cap 1 is completed, the finished caps 1′ are gathered to the inlet of the output disk and pushed out into a collection member (not shown). After repeated test, it proves that these machine 100 and 200 are very accurate and the operation is quick that it finishes several hundreds of the caps 1′ per one minute (as shown in FIGS. 11 to 14).

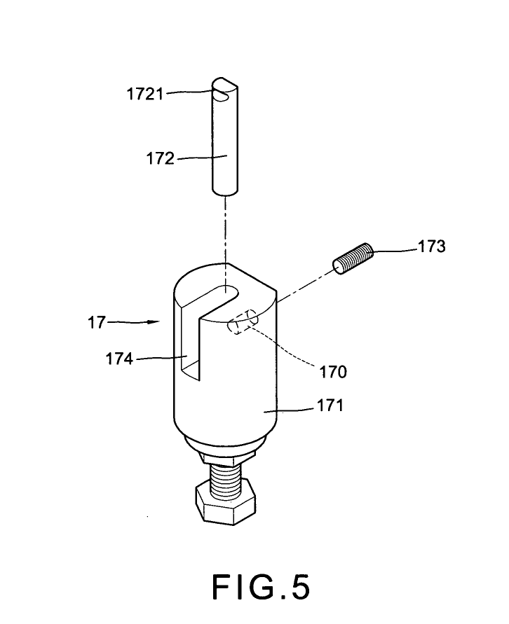

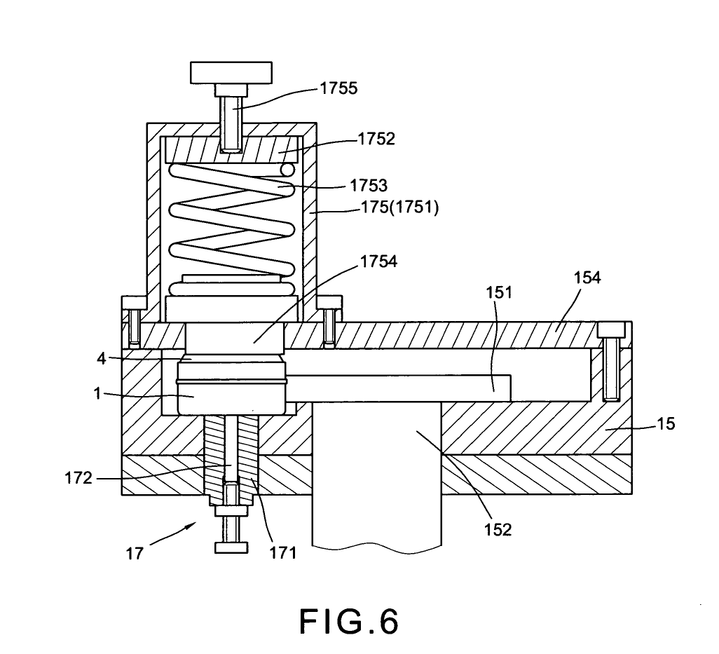

FIG. 5 shows an alternate arrangement of the chips remover 17. The change is that the stopping member 175 (as shown in FIG. 6) is removed and instead of is a cover plate 155 covering the tube 171. The cover plate 155 is capable of keeping cap 1 to be balancedly passing through and not to move upward. The chips remover can smoothly perform its chips removing action. Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

I claim:

1. A combination of two machines for making a cap of containers comprising:
a forming machine combined with a cutting machine by a transferring disk therebetween, an input disk on a side of said forming machine opposite to said transferring disk and an output disk on other side of said cutting machine opposite to the transferring disk, said disks each having an inlet, an outlet and a double-head pusher which has inverse curves on opposite side and rotatably secured to a central axis with a bearing engaged therebetween, wherein said input disk further having a chips remover in a bottom covered by a cover plate and said forming machine and said cutting marching being suspended on their tops by a pair of V-shaped supporters each of which is supported on two legs by a pair of vertical columns;
said forming machine having a main shaft at center of a circular base plate including an upper annular guide groove and lower annular guide groove, a revolving annular plate which is combined with a plurality of template on said circular base plate revolving around said main shaft including a plurality of outer concaves and a plurality of inner concaves, and an arcuate wall on an outer periphery extending from said input disk to said transferring disk to define a passage way with said revolving annular plate therebetween;
a plurality of cap forming devices spacedly and revoltingly around the main shaft;
a base box positioned under said forming and cutting machines having a motor therein under said forming machine and actuating said machines through chains;
a pair of transparent protection cover respectively covering said forming machine and said cutting machine each having several transparent doors and each of the doors having micro-switch to temporarily shut the power off.

2. The combination as recited in claim 1 wherein said upper guide annular groove has a descending section and said lower guide annular groove has a V-shaped quick descending section.

3. The combination as recited in claim 1 wherein said chips remover is composed of a tube, a cutter with blade at upper end hiding in a chips collection hole of the tube in which further has a screw hole for engaging in a threaded shank to stop against said cutter and to adjust the vertical position for the cutter and an elastic stopping member on a top of the tube having a tubular cover on top inside which is a press plate, an elastic plate biased by a spring and a nut on top which presses the press plate to jump up and downward.

4. The combination as recited in claim 1 wherein said cap forming device has a upper pressing plate and lower pressing plate each of said plate having a roller (bearing) on a back to rotatably and respectively sliding inside said upper and lower guide annular grooves, a pair of axial rods spacedly and penetrated through a rear side of said upper and lower pressing plates and eventually engaged with a pair of inner concaves of said revolving annular plate, a pressing axis fixedly secured to front under side of said upper pressing plate and slidably passing through said lower pressing plate and penetrating a pressing block surrounded by a U-shaped cover which is biased by a U-shaped cover and a gap defined between said pressing block and said U-shaped cover.

5. The combination as recited in claim 1 wherein said chips remover further has a chips collection hole communicating to a absorbing hole and a vacuum cleaner to absorb the chips from the absorbing hole.

6. The combination as recited in claim 1 wherein said axial rods of said cap forming device have their lower ends engaged with the inner concaves of said revolving annular plate.

7. The combination as recited in claim 1 wherein said stopping member is replaced with a cover plate.
